(19) United States
(12) Patent Application Publication
(10) Pub. No.: US 2024/0058843 A1
(43) Pub. Date: Feb. 22, 2024

(54) SCREEN AND SCREEN RETENTION SYSTEM FOR A SHALE SHAKER

(71) Applicant: 7Dynamics, LLC., The Woodlands, TX (US)

(72) Inventor: CARLOS GARZA, The Woodlands, TX (US)

(21) Appl. No.: 18/036,089

(22) PCT Filed: Nov. 2, 2021
(86) PCT No.: PCT/US2021/057749

§ 371 Date: May 9, 2023

Related U.S. Application Data
(60) Provisional application No. 63/111,411, filed on Nov. 9, 2020.

(51) Int. Cl. B07B 1/46

(52) U.S. Cl. CPC B07B 1/4663; B07B 1/4618; B07B 1/4672; E21B 21/065

(57) ABSTRACT

A screen assembly includes primary screens, each comprising a rib coupled to a perforated plate and extending vertically above a woven mesh. The primary screens are held rigidly to a basket of a shale shaker in near-flat shape after application of a preload with preloading mechanisms on the rib. The application of the preload deforms upper and lower rails of the basket and increases screen support stiffness during dynamic operation. A scalper screen can be mounted on the shaker on top of the primary screens and locked by the same preloading mechanisms as the primary screens. Vibrator motors are mounted near the side walls of the basket. The basket can comprise a torsional tube, and a tension beam or tube disposed parallel and above the torsion tube, to provide efficient mounting of the vibrator motors.

### FIELD OF THE INVENTION

This invention relates to screens and methods and apparatus for screening used in shale shakers for the separation of drill cuttings from drilling mud.

### BACKGROUND INFORMATION

Shale shakers are used as the primary equipment for removing drill cuttings from drilling mud during drilling operations. The cuttings are removed by feeding returning drilling fluid from the wellbore into a shale shaker that has a relatively large area fitted with screens which allows fluid and particles smaller than the mesh aperture to pass through while keeping and conveying particles larger than the mesh to the discard end of the shaker basket.

The fluid passing through the screen and the conveyance of the solids are aided by the vibration motion imparted on the screens. Vibration breaks the surface tension of the fluid, increases conductance across the meshed area; it also provides the displacement and acceleration needed to convey the solids in the desired direction across the entire screen length.

Vibration is typically imparted to the shaker basket by two rotationally unbalanced sources oriented in a way to create the desired motion at a specific angle relative to the screen surface.

During the vibration cycle, the shaker basket experiences inertial loading at each direction reversal which generates fully reversal stresses at structural members of the basket, specifically those on the stiffest path from the source to the process material. Typically, baskets are reinforced in these areas. This increases the mass but also the inertial loading, which reduces the overall effect of the vibration source constant output.

Efficiency of the shaker is measured by the ability of the equipment to separate particles of a desired size and larger from entering the downstream effluent flow of the system. Screens play a significant role in the shaker efficiency, and it can affect it by means of fluid bypass on areas where the top mesh of the screen is ruptured or through joints between screens and between screens and basket.

Typically, screens are constructed in two ways, hook-strip and pre-tensioned. Hook-strip type screens consist of several layers of mesh stacked together and clamped at opposite ends by a stiffer structural member which will serve as the connection to the basket tensioning system. Screens are then stretched over a crown support structure in the basket to provide stiffness to carry the drill cuttings.

Pre-tensioned screens, on the other hand, are constructed by fixing multiple layers of mesh of different wire diameter and wire spacing to a substrate plate of structural steel that has large openings for the fluid to pass through while providing support for the relatively weaker meshes that adhere to it. The plate is then fixed to a frame made of structural beams which provides additional support for the screen. Typically, pre-tensioned screens rely on support at the perimeter of the frame for transferring the loads and being secured to the shaker basket.

The high-efficiency shaker systems use the pre-tensioned screens due to the consistency of screen tension and ease of screen installation. Typically, pre-tensioned screens are secured to the basket by one of the following prior art methods: a) by pushing opposite ends of the screen frame down over a crown substrate, b) by securing two or three edges of the screen with pneumatic bladder without any support in the middle, c) by compressing edges of the screen and deforming over concave support frame and d) by pulling edges of the screen mounted over a crown substrate.

The high-efficiency shaker systems presented above rely on unfavorable mechanisms to store elastic energy to subsequently provide the necessary force to keep the screen rigidly attached to the basket and move synchronously with the vibrating sources.

The current methods of securing pre-tensioned screens impart additional stretch force to the original pretension in the mesh, which can significantly reduce the life of the screen in localized areas where the above-mentioned additional stretching is concentrated. This stretching comes because of the deformation of the screen over a crown or curved support or due to direct tension applied on the screen to produce the downforce over a curved surface. Additionally, having a slightly curved surface, either concave or convex for the purpose of screen preload, generates an uneven fluid depth and solids accumulation and flow path, which increases wear on specific areas, reducing screen life and separation efficiency.

Additionally, the current systems of securing pre-tensioned screens lack one or various design features to ensure a simple, reliable, and easy to maintain sealing between the screen and the basket and in between screens. Some of the current issues are due to seals being in the clamping load path, running on curved surfaces or across uneven planes, and under uneven screen preload.

### SUMMARY

In one aspect, the disclosure describes a screen and screen retention system where the screen is rigidly attached to the basket of a shale shaker while also staying in a nearly flat shape and nearly unmodified from the original manufactured shape.

The disclosure also describes the design of the basket which implements the screen retention system. The design is in such a way that it is the basket structure instead of the screen that absorbs and stores the elastic energy required to provide the force for the retention of the screen. This design also minimizes screen deflection variation across the width of the screen by providing an initial preload that induces a deflection of the basket structure that is larger than the expected loads encountered during operation of the shale shaker; therefore increasing the screen support stiffness.

In a way, this design uses longitudinal and transverse rails positioned on opposite sides of the screen, top side and bottom side, and are preloaded in opposite directions so as to deflect away from the screen. These rails can be in one or more places in the inner portion of the screen, other than the edges. The screen provides the rigid connection between the top and bottom rails. This connection is provided at each pair of upper and lower longitudinal rails, and runs parallel to the material flow in the basket (i.e., in the longitudinal direction). The preload mechanism is done via pneumatic bladder or mechanical linkage, and it pushes against the upper longitudinal rail and the screen top side.

By means of the preload during screen installation, the transverse rails are kept in tension, increasing their structural stiffness. Being deflected in opposite directions and connected by the longitudinal rails, the preload mechanism and the screen provides increased stiffness in both directions of the vibration motion cycle.

In another aspect, this disclosure describes a screen which includes a rib located at a place other than the edges of the screen. The rib provides a load-bearing surface that is located a distance above the top surface of the screen and away from the mesh to minimize interference with solids conveyance and flow. The rib carries the preload with negligible deflection and has a streamlined cross-sectional profile to reduce the effect on mesh open area and solids flow. Optionally, the screen can include more than one rib.

In a way, the rib is provided by dividing the perforated plate of the screen into n+1 plate segments, n being the number of ribs. Each rib can be achieved by bending the side of two adjacent plate segments, or by fitting additional beams to the side of two adjacent plate segments via mechanical connection, that can be permanent or removable. The top of the rib provides a support area which can be flat or at a specific angle other than flat.

In some examples, the rib also serves as a support to connect a scalper screen for pre-screening the mud. Advantageously the scalper screen is supported by two ribs, and seats between each rib and its preload mechanism uses the same clamping force to retain both primary and scalper screens in place.

The scalper screen can be of unibody type or have a replaceable screen surface and reusable screen body.

In another aspect, the disclosure describes the use of one or multiple permanent magnets located on the screen body. When the screen is properly installed in the basket, the magnets should align and be near magnetic sensors. The magnetic sensor will detect whether the screen is in a correct position and allow for adequate shaker operation. These magnets can be used to determine whether the seal at the back edge of the screen, which is under fluid and not accessible for visual inspection, is properly engaged. Additionally, multiple magnetic sensors can be used along with control logic to provide additional information like the type of screen mesh being used.

In a similar approach, an alternative method for screen detection using HALL effect sensors is also described. HALL effect sensors do not require permanent magnets to detect position, but a ferromagnetic part of the screen near the HALL effect sensor. Advantageously, this HALL effect sensor can reduce the cost of screen detection by means of the elimination of magnets on each screen.

### BRIEF DESCRIPTION OF THE DRAWINGS

FIG. 1 shows a front view of the basket and screen design during screen installation prior to the screen retention according to an example.

FIG. 2 shows a longitudinal cross-sectional view of the basket and screen shown in FIG. 1.

FIG. 3 shows a front view of the basket and screen design after a preload is applied for retention of the screen according to an example.

FIG. 4 shows a perspective view of the replaceable primary screen according to an example.

FIG. 5 shows a perspective view with a cut out of the replaceable primary screen according to an example.

FIG. 6 shows a bottom view of the replaceable primary screen according to an example.

FIGS. 7, 8, and 9 show detail of connections between adjacent primary screens according to an example.

FIG. 10 shows a front view of the basket illustrating the installation of a scalper screen on ribs of the primary screen.

FIG. 11 shows a perspective view of the scalper screen according to an example.

FIG. 12 shows a perspective of the alternate construction of the scalper screen with the replaceable screening area.

FIGS. 13, 14, and 15 show perspective views of another method of construction of the scalper screen with a polyurethane molded part.

FIG. 16 shows a portion of the screening area of the scalper screen shown in FIG. 14 or 15.

FIGS. 17, 18, and 19 show example mechanisms that hold the scalper screen up.

FIG. 20 shows a cross-section view of the rear end of the basket detailing the location of permanent magnets and magnetic sensors according to an example.

FIGS. 21 and 22 illustrate a design for mounting motors in a basket of a shale shaker.

FIG. 23 shows an example of how the motor base plates shown in FIGS. 21 and 22 are connected to the main torsional tube and the secondary tension beam or tube, also shown in FIGS. 21 and 22.

### DETAILED DESCRIPTION

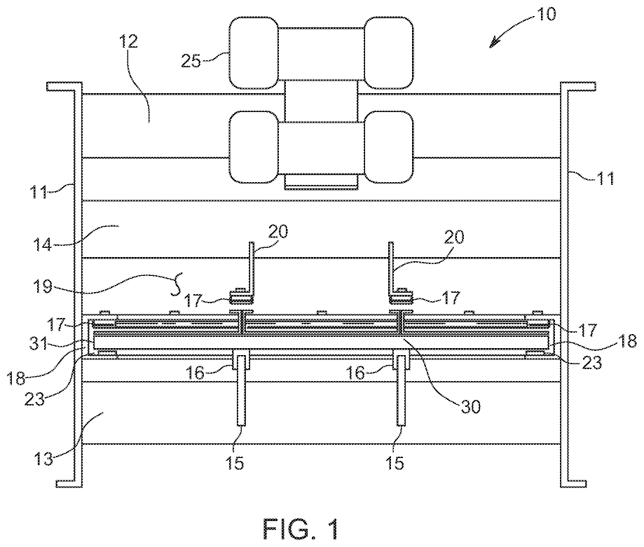

FIG. 1 shows the basket 10 with the replaceable primary screen 30 during screen installation and prior to screen preload. The basket is comprised of two opposite side walls 11 attached by transverse structural members, including the motor mount support 12 with vibrator motors 25, multiple lower transverse rails 13, and multiple upper transverse rails 14. Two lower longitudinal rails 15 connect the multiple lower transverse rails 13. A replaceable wear component 16 is inserted in the top edge of each lower longitudinal rail 15 and runs the entire length of the screening area. During installation, the screen 30 is supported by the two lower longitudinal rails 15. Pneumatic mechanically actuated preloading mechanisms 17, for example, pneumatic bladders, are located on the C-shaped rails 18 at each side wall 11 and on the two upper longitudinal rails 20. The C-shaped rails 18 continue from the sidewalls 11 into the basket back wall 19 to provide a continuous seal between the top of the screen 30 and the walls of the basket 10. During screen installation, the preloading mechanisms 17 are deflated, allowing for space in between the screen 30 and the preloading mechanisms 17. Another replaceable wear component 23 is located between the bottom internal face of the C-shaped rail 18 and the screen frame 31. A gap between the screen frame 31 and the wear component 23 exists prior to the application of the screen retention load.

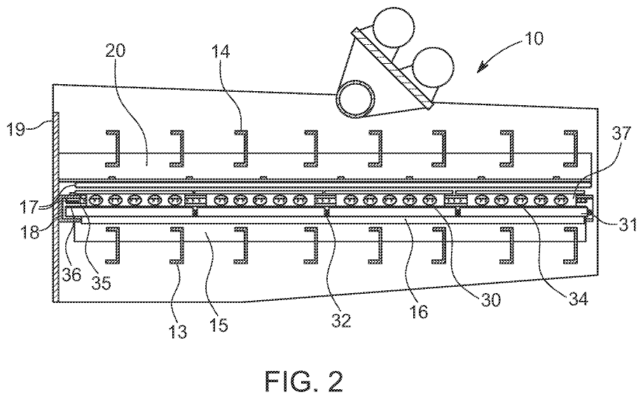

FIG. 2 shows the longitudinal cross-section of the basket 10 with a screen assembly installed. The screen assembly includes four screens 30. Upper longitudinal rail 20 is connected to multiple upper transverse rails 14. Similarly, multiple lower transverse rails 13 are connected to lower longitudinal rail 15. Replaceable wear component 16 is located at the top edge of the lower longitudinal rail 15 and runs the entire length of the screening area. Screen frame 31 rests on top of replaceable wear component 16.

The preloading mechanisms 17 are located in the C-shaped rail 18 on back wall 19 and below the upper longitudinal rail 20.

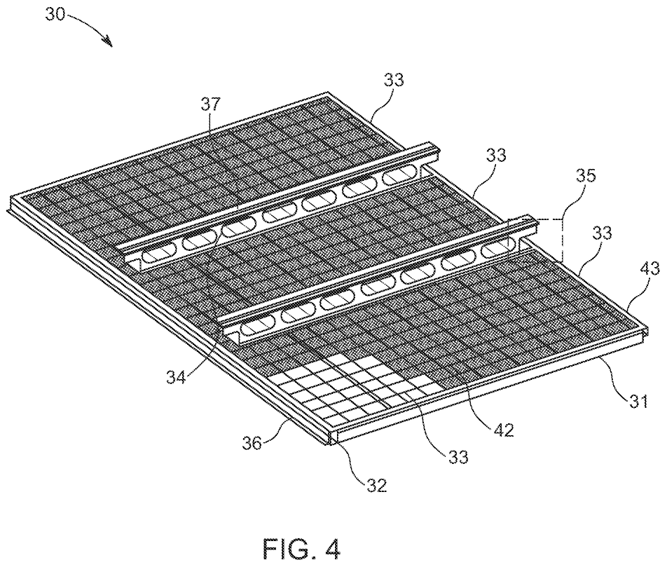

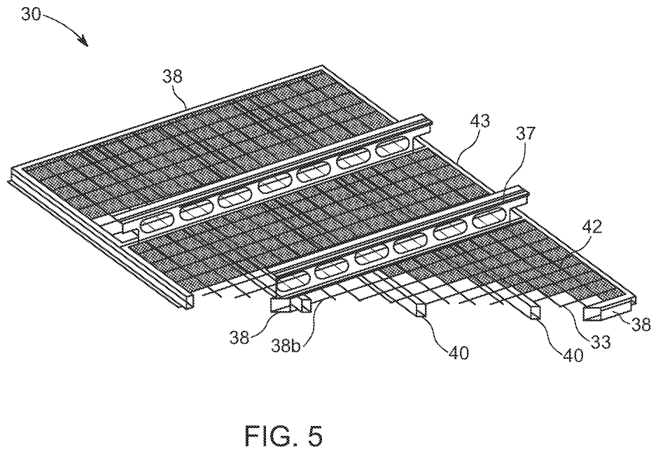

Screen seals 32 are located between each screen 30 right under the gap between perforated plates 33 (in FIGS. 4 and 5) of each screen and are squeezed between screen frames 31.

The rib 37 shows multiple apertures 34 to reduce weight and allow fluid leveling across the screen area. The rib 37 also has a cutout 35 at the edge that extends from screen mesh surface 42 (in FIG. 4) to a height sufficient to clear the upper face of the C-shaped rail 18 and to allow for the preloading mechanisms 17 to properly sit across the back edge of the screen on the back wall 19 of the basket.

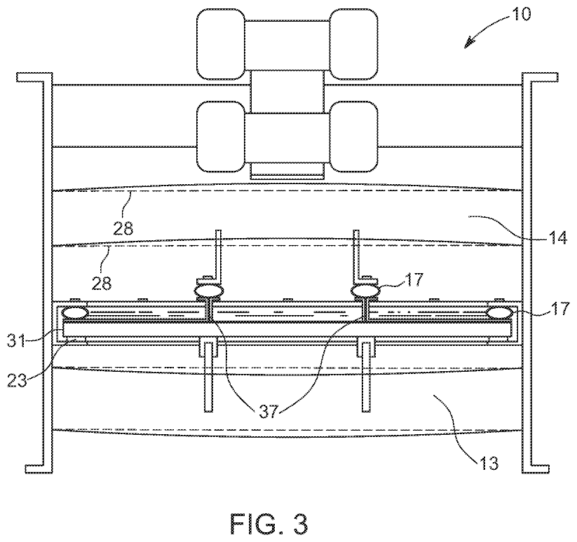

FIG. 3 shows the front view of the basket 10 with the preloading mechanisms 17 energized. Upper transverse rails 14 are deflected upwards while lower transverse rails 13 are deflected downwards. Dotted lines 28 show the original unloaded shape of the transverse rails. The screen frame 31 is pressed against replaceable wear component 23 on C-shaped rail 18, closing the original gap and allowing the screen to stay flat after the preloading mechanisms are energized.

Screen retention load is stored as elastic energy by means of the deformation in the upper 14 and lower 13 transverse rails. The screen retention load is transmitted to the upper and lower transverse rails through the screen frame 31 and the screen rib 37, which is in direct contact with preloading mechanisms 17.

The deflection during screen preload is larger than the deflection that would otherwise be generated by inertial forces without preload, therefore increasing screen support stiffness during operation.

The screens (30) are held rigidly in near-flat shape after application of the preload. As used herein and in the appended claims, a “near-flat” shape means having a curvature equal to or less than 1.7e-4 inch, wherein the curvature refers to the inverse of the radius of curvature.

FIG. 4 shows the perspective view of the primary screen according to one possible construction. The screen 30 consists of screen frame 31, three segments of the perforated plate 33, screen seal 32, seal retainer plate 36, and woven mesh 42 on top of the segments of the perforated plate 33. The ribs 37 are an integral part of segments of the perforated plate 33 and formed by bending said segments. The segments are then joined side by side at the bent edge, joined mechanically to the screen frame 31, and to one another at the rib 37. Rib 37 has multiple apertures 34 across the length to reduce weight and allow fluid level equalization across both sides of the rib 37. The two load rib cutouts 35 at both ends of the rib 37 allow the preloading mechanisms 17 (in FIG. 1, 2 or 3) to seal against the perforated plate 33 and C-shaped rail 18 (in FIG. 1 or 2) across the screen edge facing the back wall 19 (in FIG. 1 or 2). The preloading mechanisms 17, such as a pneumatic bladder, makes a continuous contact from back edge to side edges of the screen 30.

FIG. 5 shows a sectioned view of the primary screen 30. The screen frame 31 comprises longitudinal beams 38, each of which sits below each junction of the segments of the perforated plate 33 directly under the bent edge that forms the rib 37 to provide a stiff structural path to transmit the screen preload from the upper longitudinal rail 20 to the lower longitudinal rail 15. One longitudinal beam 38 is located at each end of the screen 30. Multiple transverse beams 40, 43 complete the screen frame 31, which supports the perforated plates 33. Transverse beam 43 is on one edge of the primary screen 30 that is opposite to the edge where the screen seal 32 and the seal retainer plate 36 are provided. Transverse beam 43 is of a smaller square cross-section than transverse beams 40. The transverse beam members 40, 43 preferably run as one piece from end to end, and the beams 38 are made of sections and connectors 38b to the transverse beam members 40, 43. The sections and the connectors can have a thickness as low as 0.035 inch, which reduces the weight of the screen 30 up to 6 lbs.

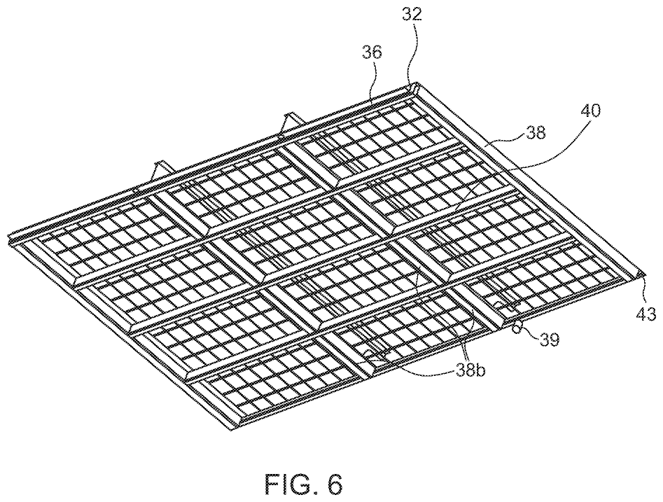

FIG. 6 shows a bottom view of the primary screen 30. The design of the screen frame 31 allows the transverse beams 40 to function as a mud load bearing structural component decoupled from the preload and elastic energy storage for screen retention and dynamic load, which is carried by the beams 38 and connectors 38b and the longitudinal supports of the shaker. This allows for a stiffer screen surface for solids conveyance and dynamic loading while still reducing mass for handling and installation. Ratio of stiffness to mass can be maximized.

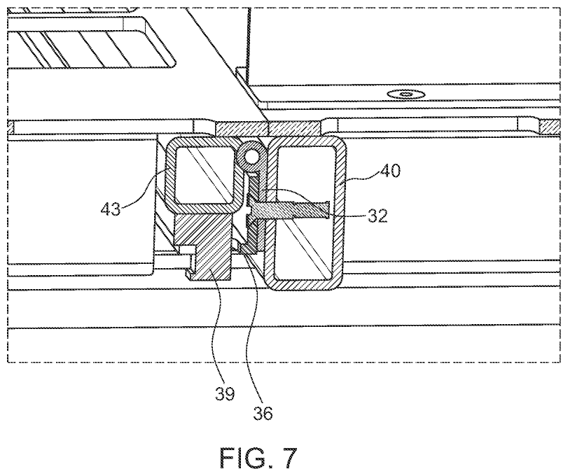

FIGS. 7, 8, and 9 illustrate the way adjacent screens 30 are connected end-to-end, as is shown in FIG. 2, via pin connections. FIG. 7 is a cross-section through the pin connection. FIG. 8 is a lateral view illustrating the position of two adjacent screens 30 at the initial step of the connection. FIG. 8 is a bottom view illustrating the compression of the bulb of the seal 32 once adjacent screens 30 are horizontal.

To make the screens 30 interconnect, the screen seal 32 and the seal retainer plate 36 on the edge of a first screen 30 are juxtaposed with the transverse beam 43 of a second screen 30. The seal retainer plate 36, which is L-shaped, is mechanically connected to the face of a transverse beam member 40 of the first screen 30 and holds the seal 32, which is P-shaped, in between a vertical portion of the seal retainer plate 36 and the transverse beam member 40. The horizontal portion of the retainer plate 36 serves as a support for the transverse member 43 of the second screen, which has a square cross-section. This horizontal portion of the seal retainer plate 36 has slots that mate with pins 39 mounted on the bottom face of the transverse member 43.

The bulb 32b of the screen seal 32 is then squeezed between the transverse member 40 of the first screen 30 and the transverse member 43 of the second screen 30 once the first and second screens 30 are horizontal. The force to squeeze the seal 32 is provided by the mechanical advantage provided by the linkage formed by the vertical flat face 45 of the pin 39 pushing against slot face 36b in the seal retainer plate 36 when the screens are lifted from the initial tilted angle shown in FIG. 8 to the final horizontal position shown in FIG. 9.

As shown in FIG. 6, the pin 39 is preferably located to the side of central longitudinal beam 38 (i.e., a beam made of sections and connectors 38b).

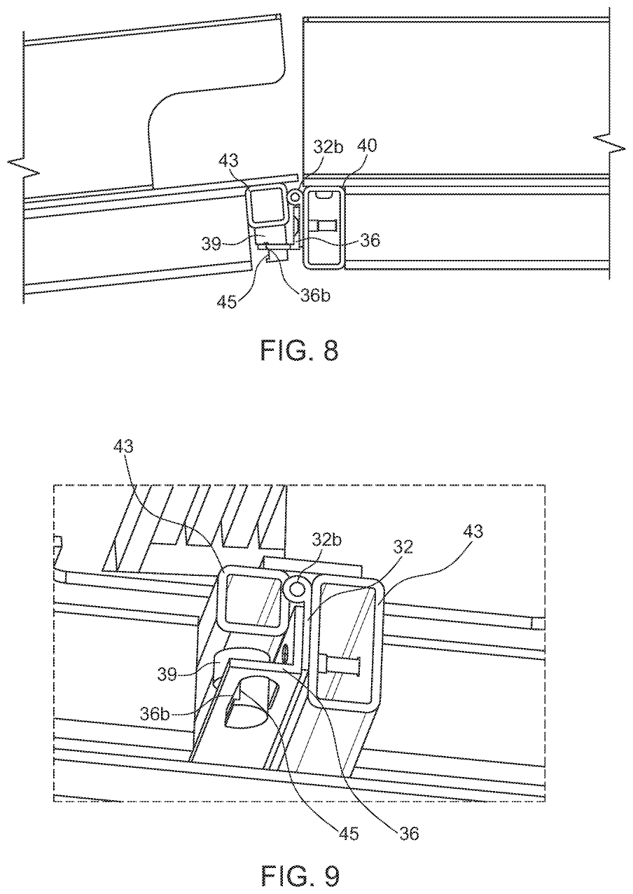

FIG. 10 shows the front view of the basket 10 with the scalper screen 50 installed in between the ribs 37 of the primary screen 30 and the preloading mechanisms 17. Once actuated, the preloading mechanisms 17 will press the support tabs 51 of the scalper screen 50 against the ribs 37 of the primary screen 30, thus securing both screens in place.

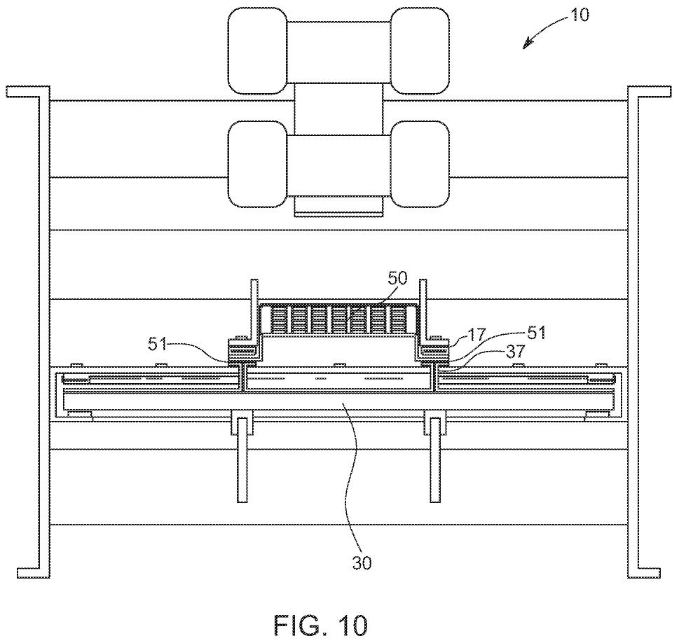

FIG. 11 shows a perspective view of the scalper screen 50. The scalper screen 50 includes a frame and a perforated screening plate or lattice 53. The frame comprises sidewalls 52 and support tabs 51. Optionally, the sidewalls 52 of the scalper screen 50 have a triangular shape to provide a tilted angle between the support tabs 51 of the scalper screen 50 and the screening plate or lattice 53 of the scalper screen 50. Alternatively, the sidewalls 52 of the scalper screen 50 can have a rectangular shape to provide a flat screening plate or lattice 53. The screening area includes a woven mesh 42 that is attached on the screening plate or lattice 53.

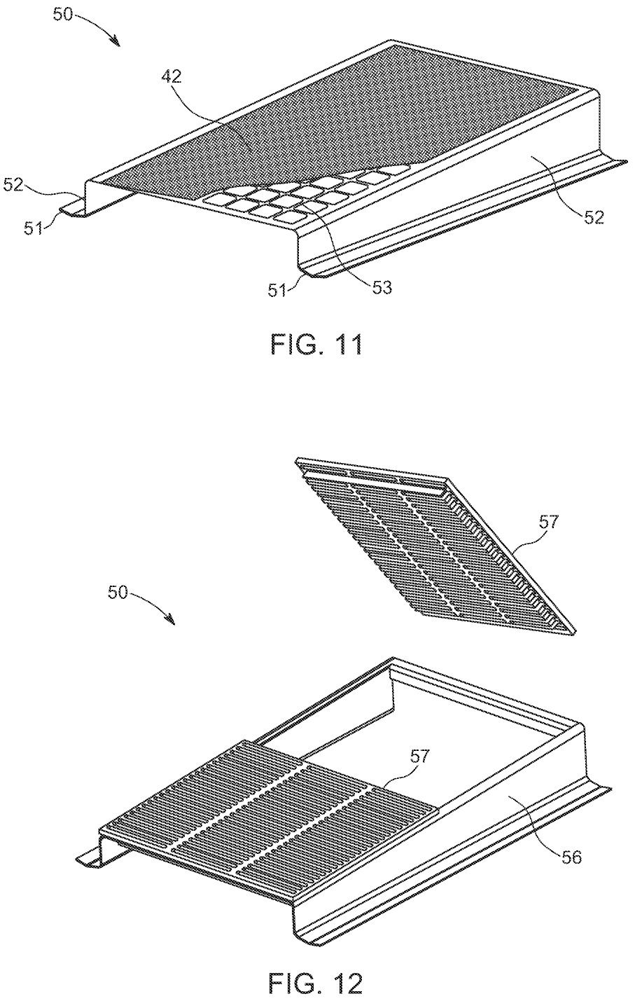

FIG. 12 shows a perspective view of the alternative method of construction of the scalper screen 50. The screening plate of the scalper screen 50 includes a frame 56 and a removable/replaceable screening area 57. While the removable/replaceable screening area 57 is illustrated tilted, it can be alternatively flat.

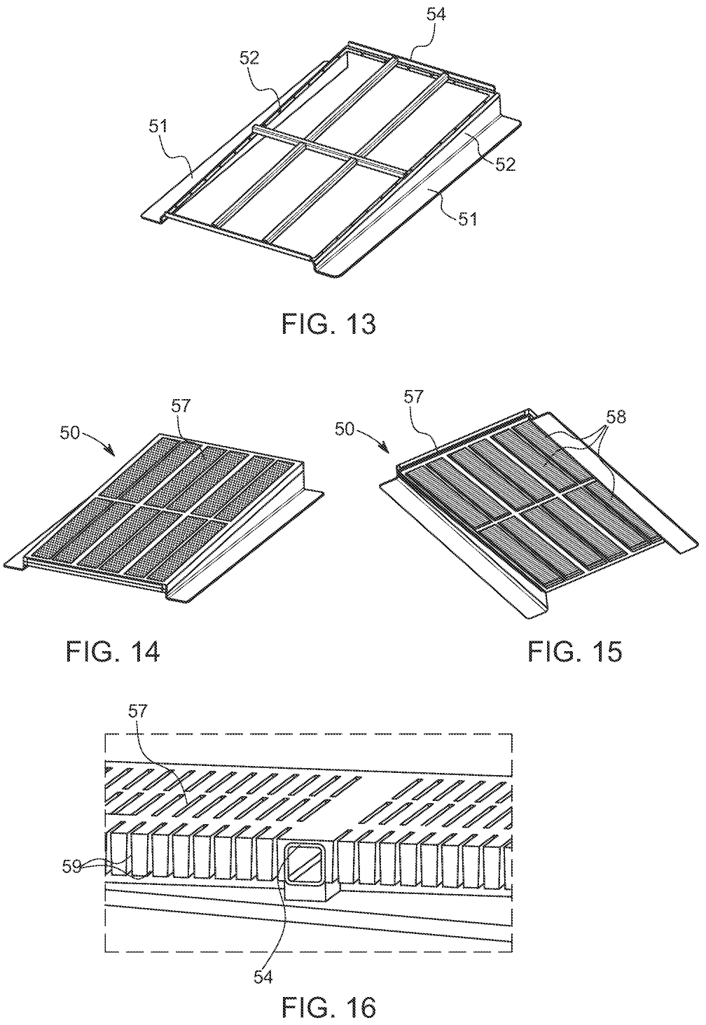

FIGS. 13, 14, and 15 show perspective views of another method of construction of the scalper screen 50. The method for construction of the screen 50 starts by forming a frame with bent plates to form sidewalls 52, and tabs 51. Then, the central plate or lattice 53, which is made of square tubes 54, is added. For example, the central plate or lattice 53 that can be welded to the sidewalls 52 to provide the appropriate stiffness and serve as a bind area for a polyurethane molded part that forms the screening area 57 (in FIG. 14 or 15).

Lastly, the screening area 57 is in one piece and molded in place to reduce complexity and potential failures. Again, while the removable/replaceable screening area 57 is illustrated tilted, it can be alternatively flat. For example, the screening area 57 can be made by pouring polyurethane to make the screening area 57 light and stiff with a durable surface. Thus a polyurethane piece is integral with the central plate or lattice 53 and can be mounted on the shaker on top of the primary screens 30 (in FIG. 10) and locked by the same preloading mechanisms 17 as the primary screens 30.

As seen in FIG. 15, the bottom profile of the screening area 57 can be molded with pockets 58 to reduce thickness of the screening area 57.

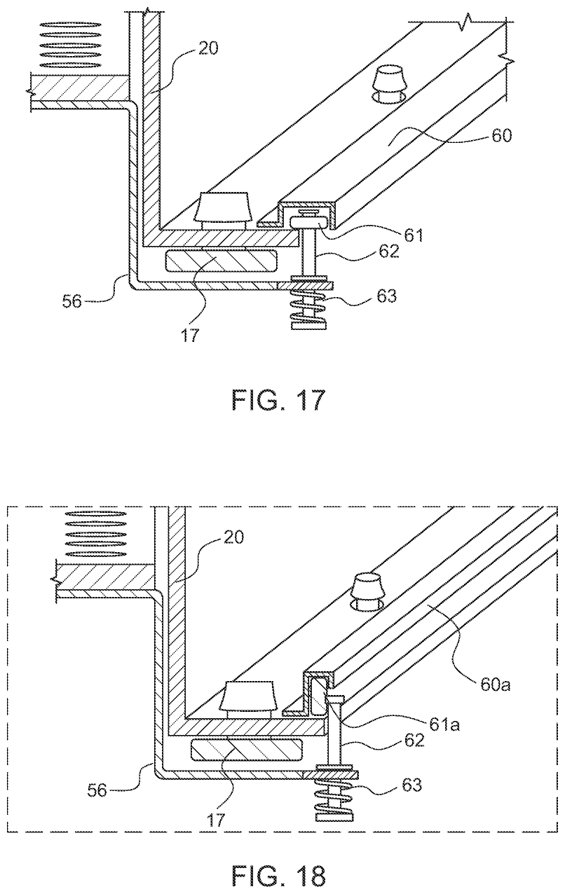

FIG. 16 shows a portion of the screening area 57 shown in FIG. 14 or 15. The screening area 57 is molded around square tubes 54. The screening area 57 includes taper slots 59 (i e, thinner above and wider below).

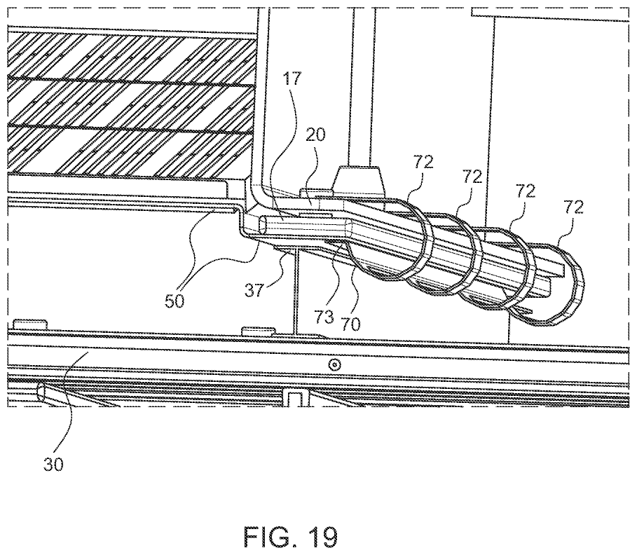

FIGS. 17 and 18 show example mechanisms that hold the scalper screen 50 up when the pneumatic or mechanically actuated preloading mechanisms 17 are turned off. This way, primary screen 30 (in FIG. 10) can be removed without the need to remove scalper screen 50, which will make the shaker more user-friendly. For example, the mechanism includes a support pin 62 that is spring-loaded by spring 63 and is installed on the frame 56 of the scalper screen 50. A wheel 61 or 61a and rides on the tab 51 of the frame 56 and in a channel formed by a guide rail 60 or 60a installed on the top face of the upper longitudinal 20. The wheel 61 turns on a vertical axis. The wheel 61a turns on a horizontal axis. The rotation axis of the wheel can have other orientations. The support pin 62 passes through a mounting hole provided in the scalper screen 50. For example, four mounting holes can be provided on legs extending from the tabs 51 near the corners of the scalper screen 50.

FIG. 19 shows a C-clip spring guide 70 holding the scalper screens 50 lifted above rib 37. This C-clip spring guide 70 allows for primary screens 30 to be removed without the need to remove scalper screens 37. The C-clip spring guide 70 can be designed to hold the scalper screen 50 statically but not during dynamics operation.

C-clip elements 72 can deform when preloading mechanism 17 (e.g., pneumatic clamping) is activated to allow the bottom face of scalper screen 50 to contact the rib 37. The C-clip spring guide 70 is formed by at least 2 C-clip elements 72 joined together by a continuous plate 73 on the bottom end of the C-clip elements 72. The continuous plate 73 serves as guide support for the scalper screen 50. The upper end of the C-clip elements 72 is mechanically attached to the top face of the upper longitudinal rail 20.

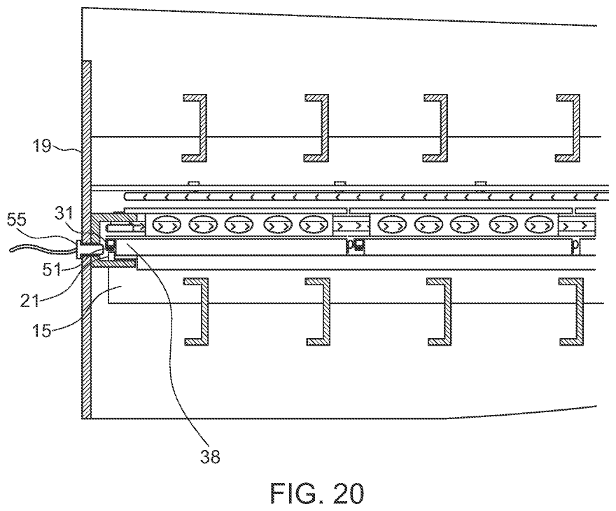

FIG. 20 shows the permanent magnet 51 mounted on the edge of screen frame 31 facing basket back wall 19. A longitudinal beam 38 of the screen frame 31 contacts the positive stop 21 at the end of the lower longitudinal rail 15. A magnetic sensor 55 is mounted through the back wall 19 and C-shaped rail 18 and aligns to the location of the permanent magnet 51. When the screen is properly installed, a specified distance within the range of magnetic detection exists between sensor 55 and magnet 51. Magnetic detection can be used now to prevent starting the shaker without primary screens 30 and with scalper screens 50 supported by the C-clip spring guide 70 (in FIG. 19).

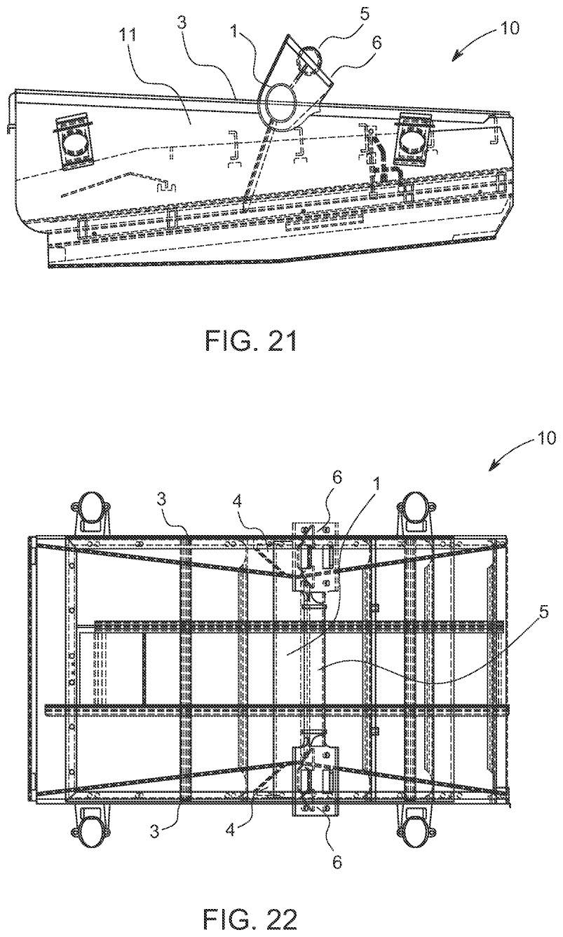

FIGS. 21 and 22 illustrate a design for mounting motors in basket 10 of a shale shaker that can improve basket rigidity, shorten the path of transmission of vibration from its source (the unbalanced motors) to the working surface of the screens, such as the primary screen 30 and the scalper screen 50 shown in FIG. 10, achieve mass reduction, and ease manufacturing.

The motors are mounted near the side walls 11 of the basket 10. The side walls 11 transmit the vibration to the structural supports of the screens, such as the C-shaped rails 18, the lower transverse rails 13 and the upper transverse rails 14 shown in FIGS. 1 and 2. Then, the vibration is transmitted to the screens.

The motors are positioned at the appropriate angle to create the desired motion at a specific angle relative to the screen surface for proper solids conveyance. The motors are also raised to avoid interference with the basket walls. To transmit rotation/torque vibration from the unbalanced motors to the side walls 11, the basket 10 includes a main torsional tube 1 connected to the side walls 11. To provide enough structural strength to mount the motors, the basket 10 also includes a secondary tension beam or tube 5 connected parallel and above the main torsion tube either to the motor base plates 6 or to the motor housings. When connected to the motor housings, the axis of the secondary tension beam or tube 5 preferably coincides with, or is at least located near, the centerline of the motor shafts. The secondary tension beam or tube 5 resists horizontal displacement of a motor relative to the other. The main torsional tube 1 and the secondary tension beam or tube 5 are not necessarily cylindrical, and their sections can be round, oval, or rectangular or have any other shape.

The use of the main torsional tube 1 and the secondary tension beam or tube 5 can allow separating the functions of transmitting vibration transmission and adding rigidity and stiffness to the mounting of the motors. Thus, the overall structural rigidity and the stiffness to mass ratio can be improved significantly.

Each side wall 11 is bent towards the inside of the basket 10 to provide the folds 3. Each fold 3 can be shaped so that it is wider (e.g., the widest) at locations 4 than at the ends. Preferably, the centerline of the main torsional tube 1 aligns with, or is at least located near, the locations 4 where the folds 3 are the widest.

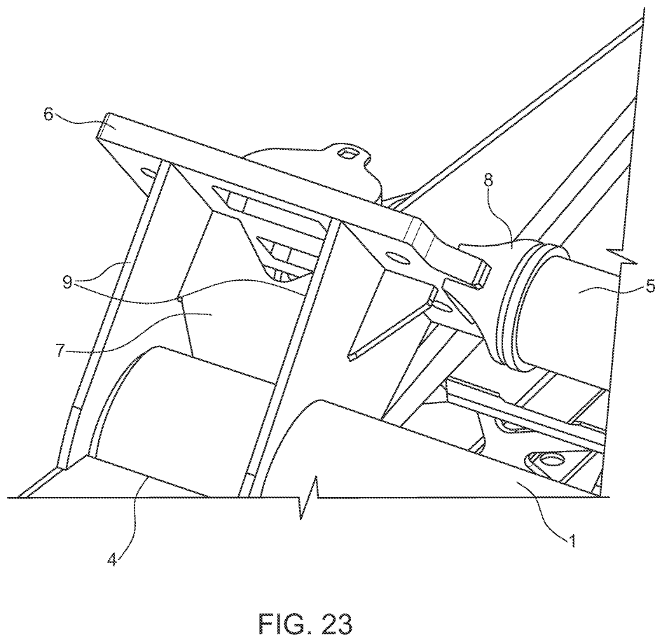

FIG. 23 illustrates an example of how the motor base plates 6 are connected to the main torsional tube 1 and the secondary tension beam or tube 5. A gusset plate 7 connects the base motor plate 6 to main torsional tube 1. The center plane of each gusset plate 7 is aligned with the centerline of the secondary tension beam or tube 5. A structural connector 8 is configured to allow the centerline of the secondary tension beam or tube 5 to be aligned with the center planes of the motor base plates 6.

In use, the screen assembly is mounted in the basket 10 of a shale shaker. The screen assembly includes at least one primary screen 30 comprising a screen frame 31, a mesh 42, and a rib 37 extending vertically above the mesh 42. The basket 10 includes an upper longitudinal rail 20, a pneumatic or mechanically actuated preloading mechanism 17 coupled below the upper longitudinal rail 20 and a lower longitudinal rail 15 located below the upper longitudinal rail 20. The upper longitudinal rail 20 and a lower longitudinal rail 15 are positioned to support an inner (or central) portion of the least one primary screen 30. For example, the rib 37 is configured to be aligned with the upper longitudinal rail 20, and the lower longitudinal supports 15 when the screen assembly is in place in the basket 10 of the shale shaker. The basket 10 also includes multiple lower transverse rails 13 connected to the lower rail 15 and to the side walls 11 of the basket 10, as well as multiple upper transverse rails 14 connected to the upper rail 20 and to the side walls 11. When actuated, the pneumatic or mechanically actuated preloading mechanism 17 generates a preload that deflects the multiple upper transverse rails 14 and the multiple lower transverse rails 13. The rib 37 transmits load from the multiple upper transverse rails 14 to the multiple lower transverse rails 13. For example, the rib 37 has a load-bearing surface 39 located at a distance above the mesh 42. Said load-bearing surface 39 is in contact with the pneumatic or mechanically actuated preloading mechanism 17 when the screen assembly is in place in the basket 10 of the shale shaker. The at least one primary screen 30 is held rigidly to the basket 10 in near-flat shape after application of the preload with the preloading mechanisms 17, preferably without inducing stresses on the mesh 42 or the screen frame 31 due to the preload. The lower screen support stiffness provided by the multiple lower transverse rails 13 is substantially equal to the lower screen support stiffness provided by the multiple lower transverse rails 13.

As such, a screen clamping force may be stored in the basket 10 as elastic energy in the multiple upper transverse rails 14 and the multiple lower transverse rails 13. The screen clamping force is larger than inertial loading at maximum vibration acceleration for reducing structural deflection during dynamic operation.

In some embodiments, the at least one primary screen 30 further comprises a perforated plate 33 supported by the screen frame 31, and the mesh 42 is supported by the perforated plate 33. The rib 37 can be coupled to the perforated plate 33, the screen frame 31. For example, the rib 37 may be integrally made from the perforated plate 33 or mechanically attached to perforated plate 33, either permanently or removably. The mesh 42 may include at least two layers of woven mesh material. The mesh 42 may be attached to the perforated plate 33.

In some embodiments, the basket 10 further comprises a back wall 19, C-shaped rails 18 positioned to retain edges of the at least one primary screen 30, wherein the C-shaped rails are located at the side walls 11 and back wall 19 of the basket 10. The rib 37 has a cutout 35 at at least one longitudinal end to allow another pneumatic or mechanically actuated preloading mechanism 17 positioned at a back wall 19 of the basket 10 to have continuous contact with a top side of the perforated plate 33. The pneumatic or mechanically actuated preloading mechanisms 17 includes a bladder inflatable pneumatically mounted in the C-shaped rails 18, the bladder being capable of having continuous contact with at least one primary screen 30 on the side walls 11 and the back wall 19.

In some embodiments, the screen frame 31 of the at least one primary screen 30 comprises side beams 38 located at two opposite ends of the primary screen 30 and under the rib 37, and central beams 38 located between the side beams 38, transverse beam members 40 that connect to the side beams 38. Preferably, the transverse beam members 40 run as one piece from end to end, and the central beams 38 are made of sections and connectors 38b to the transverse beam members 40.

In some embodiments, the basket 10 further comprises a C-clip spring guide 70, including C-clip elements 72 that can deform when the pneumatic or mechanically actuated preloading mechanisms 17 are activated. An upper end of each of the C-clip elements 72 is mechanically attached to a top face of the upper rail 20. For example, the C-clip spring guide 70 is formed by at least 2 C-clip elements 72 joined together by a continuous plate 73 on the bottom end of the C-clip elements 72. The C-clip spring guide 70 serves as guide support for a scalper screen 50, to hold the scalper screen 50 lifted above rib 37 and is deformable to allow the scalper screen 50 to contact the rib 37. The C-clip spring guide 70 allows removal of the at least one primary screen 30 without removing the scalper screen 50. The scalper screen 50 is installed on top of the rib 37 of the least one primary screen 30. The scalper screen 50 is retained in place using the pneumatic or mechanically actuated preloading mechanism 17 when the screen assembly is in place in the basket 10 of the shale shaker.

In some embodiments, the scalper screen 50 comprises a perforated screening plate or lattice 53, a frame 56 that is folded at multiple edges to provide a support surface for the screening plate or lattice 53, and support tabs 51. Preferably, the support surface and the support tabs 51 are at a slanted angle. The screening plate or lattice 53 supports a screening area 57 that is made by molding a substance over the plate or lattice 53. The screening area 57 includes slots formed in openings in the perforated screening plate or lattice 53, preferably where the screening area 57 has molded pockets to reduce thickness of the slots. The screening area 57 is made of one of polyurethane, plastic, fiber-reinforced plastic, and a combination thereof.

In some embodiments, the screen assembly further comprises at least one permanent magnet 51 mounted on a body of the screen assembly. The basket 10 can comprise one or more magnetic sensors 55 configured for the detection of one or more permanent magnets 51 mounted on a screen assembly. Alternatively, the basket 10 can comprise one or more HALL sensors 55 configured for the detection of screen position and velocity. A position of the screen assembly can be detected using the one or more magnetic sensors 55. Also, a type of screen assembly can be detected using signals generated by the one or more magnetic sensors 55.

Specific embodiments of the invention are shown by way of example in the drawings and description. It should be understood, however, that the drawings and detailed description thereto are not intended to limit the claims to the particular form disclosed, but on the contrary, the intention is to cover all modifications, equivalents, and alternatives falling within the scope of the claims.

1-45. (canceled)

46. A screen assembly for use in a basket of a shale shaker, the basket including an upper longitudinal rail, a pneumatic or mechanically actuated preloading mechanism coupled below the upper longitudinal rail, and a lower longitudinal supports located below the upper longitudinal rail, the screen assembly including a primary screen comprising:
a screen frame having side beams located at two opposite ends of the primary screen and under a rib, the screen frame further having central beams located between the side beams, the screen frame further having transverse beam members that connect to the side beams;
a perforated plate supported by the screen frame;
woven mesh, wherein the woven mesh is supported by the perforated plate; and
the rib being coupled to the perforated plate, supported by the screen frame, and extending vertically above the woven mesh;
wherein the rib is configured to be aligned with the upper longitudinal rail and the lower longitudinal supports when the screen assembly is in place in the basket of the shale shaker;
wherein one of the transverse beam members is located near an edge of the primary screen; and
wherein another one of the transverse beam members that is located near an opposite edge of the primary screen has a first cross-section that is smaller than a second cross-section of the one of the transverse beam members.

47. The screen assembly of claim 46, wherein the rib has a load-bearing surface located at a distance above the mesh.

48. The screen assembly of claim 47, wherein said load-bearing surface is configured to be in contact with the pneumatic or mechanically actuated preloading mechanism when the screen assembly is in place in the basket of the shale shaker.

49. The screen assembly of claim 46, wherein the rib is one of integrally made from the perforated plate, or mechanically attached to the perforated plate, either permanently or removably.

50. The screen assembly of claim 46, wherein the rib has a cutout at at least one longitudinal end to allow another pneumatic or mechanically actuated preloading mechanism positioned at a back wall of the basket to have continuous contact with a top side of the perforated plate.

51. The screen assembly of claim 46, wherein the rib is made of steel, aluminum, plastic, rubber, composite, polymer, or combination thereof.

52. The screen assembly of claim 46, further comprising a scalper screen configured to be installed on top of the rib of the primary screen and capable of being retained in place using the pneumatic or mechanically actuated preloading mechanism when the screen assembly is in place in the basket of the shale shaker.

53. The screen assembly of claim 52, wherein the scalper screen comprises:
a perforated screening plate or lattice, the screening plate or lattice supporting a screening area; and
a frame that is folded at multiple edges to provide a support surface for the screening plate or lattice and support tabs.

54. The screen assembly of claim 53, wherein the screening area is made by molding a substance over the plate or lattice, wherein the screening area includes slots formed in openings in the perforated screening plate or lattice, preferably wherein the screening area has molded pockets to reduce thickness of the slots.

55. The screen assembly of claim 54, wherein the screening area is made of one of polyurethane, plastic, fiber-reinforced plastic, and combination thereof.

56. The screen assembly of claim 46, wherein the woven mesh is attached to the perforated plate by at least one of gluing, welding, and mechanical fastening.

57. The screen assembly of claim 46, wherein the woven mesh includes at least two layers of woven mesh material.

58. The screen assembly of claim 46 further comprising at least one permanent magnet mounted on a body of the screen assembly.

59. The screen assembly of claim 52, wherein the scalper screen is produced by a method comprising:
folding a frame at multiple edges to provide a support surface for a screening plate or lattice and support tabs;
providing a perforated screening plate or lattice;
molding a screening area out of polyurethane, plastic, fiber-reinforced plastic, or a combination thereof, over the screening plate or lattice, wherein the screening area includes slots separated by fins, the slots being sized to allow fluid flow and located in apertures in the perforated screening plate or lattice; and
connecting the folded frame to the perforated screening plate or lattice.

60. The screen assembly of claim 59 wherein the screening area further includes molded pockets located in the apertures in the perforated screening plate or lattice.

61. The screen assembly of claim 60 wherein the molded pockets are sized to reduce a thickness of the fins to control cross-sectional properties of the fins for dynamic load operation.

62. The screen assembly of claim 46,
wherein the first cross-section is square; and
wherein the second cross-section is rectangular.

63. The screen assembly of claim 46,
wherein the one of the transverse beam members is provided with a screen seal and a seal retainer plate;
wherein the seal retainer plate includes slots; and
wherein the other one of the transverse beam members is provided with pins.

64. The screen assembly of claim 63, wherein the screen seal is P-shaped and includes a bulb.

65. The screen assembly of claim 63, wherein the pins are located at the side of one of the central beams.
